(19) United States
(12) Patent Application Publication
(10) Pub. No.: US 2020/0194794 A1
(43) Pub. Date: Jun. 18, 2020

(54) Laminated Lithium Metal Anode With Protective Coatings

(71) Applicant: Apple Inc., Cupertino, CA (US)

(72) Inventors: Alan A. Ritchie, Menlo Park, CA (US); Karl M. Brown, Los Gatos, CA (US); Lin Ma, Santa Clara, CA (US)

(21) Appl. No.: 16/691,970

(22) Filed: Nov. 22, 2019

Related U.S. Application Data
(60) Provisional application No. 62/779,549, filed on Dec. 14, 2018.

(51) Int. Cl. H01M 4/62; H01M 4/1395; H01M 4/04; H01M 4/134; H01M 10/052

(52) U.S. Cl. CPC H01M 4/628; H01M 4/1395; H01M 4/0404; H01M 2004/027; H01M 4/0423; H01M 10/052; H01M 4/134

(57) ABSTRACT

An anode for a lithium metal battery includes a current collector, a LiPON layer on the current collector, a solid polymer layer on the LiPON layer and a porous separator laminated to the solid polymer layer. The solid polymer layer can be a linear polymer mixed with an ion conducting filler. The solid polymer layer can be a polymer matrix formed from a solidified polymer network comprising a crosslinked polymer mixed with an ion conducting filler.

### CROSS-REFERENCE TO RELATED APPLICATION(S)

This application claims the benefit of U.S. Provisional Application No. 62/779,549, filed on Dec. 14, 2018. The content of the foregoing application is incorporated herein by reference in its entirety for all purposes.

### TECHNICAL FIELD

This disclosure relates to a laminated anode for a lithium metal battery, the laminated anode including protective coatings.

### BACKGROUND

Lithium metal batteries have the potential to provide very high energy densities. However, lithium metal batteries have not been commercialized to date due at least in part to challenges associated with integrating lithium metal. One issue associated with the use of lithium metal is the corrosive effect of electrolytes on the lithium metal. The corrosive reaction results in the lithium metal forming sub-dense dendritic growth during plating and stripping cycles. The evolution of this dendritic growth of the lithium metal can result in swelling of the anode by a significant amount in a relatively small number of cycles, thereby resulting in cell impedance growth and loss of reversibility.

### SUMMARY

Disclosed herein are anodes for lithium metal batteries, lithium metal batteries comprising the anodes, and methods of making the anodes.

An anode for a lithium metal battery includes a current collector, a lithium phosphorous oxy-nitride (LiPON) layer on the current collector, a solid polymer layer on the LiPON layer and a porous separator laminated to the solid polymer layer.

The solid polymer layer can comprise one or more linear polymers and an ion conducting filler. The linear polymer can be selected from polydiallyldimethylammonium-X (polyDDA-X), wherein X can be one or more of TFSI, FSI, PF₆, Cl, Br, and I, polyvinyl butyral (PVB), polyvinylpyrrolidone (PVP), polyvinyl alcohol (PVA), polyurethane acrylate (PUA) or polyvinylidene fluoride (PVDF). The ion conducting filler can be an ionic-liquid containing electrolyte, an ionic liquid polymer, or other ion conducting fillers.

In some embodiments, the solid polymer layer can comprise a solid polymer matrix. The solid polymer matrix is a solidified polymer network comprising a crosslinked polymer mixed with an ion conducting filler.

In some embodiments, the crosslinked polymer is crosslinked poly(ethylene glycol) dimethacrylate (PEGDMA), crosslinked polyDDA-X, wherein X can be one or more of TFSI, FSI, PF₆, Cl, Br, and I, crosslinked PVB, crosslinked PVA, crosslinked PVP, crosslinked PUA or crosslinked PVDF.

In some embodiments, the ion conducting filler in the polymer matrix is linearly chained polyDDA, ionic liquid and lithium bis(fluorosulfonyl)imide (LiFSI). In some embodiments, the ion conducting filler in the polymer matrix is an ionic liquid-containing electrolyte.

In some embodiments, the solid polymer matrix is a solidified polymer network comprising a crosslinked PEGDMA matrix operated in an ion conducting filler comprising a linearly chained polyDDA-X, an ionic liquid and a lithium salt.

In some embodiments, the LiPON layer has a thickness of greater than or equal to 0.2 μm and less than or equal to 3 μm.

In some embodiments, the solid polymer matrix has a thickness of greater than or equal to 1 μm and less than or equal to 5 μm.

In some embodiments, a seed layer of lithium metal is deposited between the current collector and the LiPON layer.

A lithium metal battery is disclosed that includes an anode having a current collector, a LiPON layer on the current collector, a solid polymer layer on the LiPON layer and a porous separator laminated to the solid polymer layer. The battery further includes a cathode and liquid electrolyte. The lithium metal battery is configured to operate at a pressure of 20 PSI or less.

A method of making an anode for a lithium metal battery is also disclosed. The method can include depositing a LiPON layer onto a current collector, mixing a polymer with an ion conducting filler to produce a solution, casting the solution on the LiPON layer, laminating a porous separator onto the solution while the solution is wet and curing the solution to crosslink the polymer and form a solid polymer matrix.

### BRIEF DESCRIPTION OF THE DRAWINGS

The disclosure is best understood from the following detailed description when read in conjunction with the accompanying drawings.

FIG. 1 is a scanning electron microscope (SEM) image of a cross-section of an anode after 0.3 hours of charging, producing dendritic lithium having a thickness of 13 μm compared to a theoretical plating thickness of 1.6 μm. The cell included a copper foil anode current collector, a polyethylene separator, a cathode material comprising lithium cobalt oxide and a liquid electrolyte comprising LiFSI, DME and PYR₁₃FSI with an operating pressure of 15 PSI.

FIG. 2 is an SEM image of a cross-section of an anode nucleated with a 20 μm thick lithium seed layer. The image is taken after a single charge, illustrating the dendritic plating on top of the seed layer. The cell included a copper foil anode current collector, a polyethylene separator, a cathode material comprising lithium cobalt oxide and a liquid electrolyte comprising LiFSI, DME and PYR₁₃FSI with an operating pressure of 15 PSI.

FIG. 3 is an SEM image of an anode having a LiPON layer on the current collector. The image is taken after charging for 0.3 hours, resulting in dense plating of lithium. The cell included a copper foil anode current collector, a polyethylene separator, a cathode material comprising lithium cobalt oxide and a liquid electrolyte comprising LiFSI, DME and PYR₁₃FSI with an operating pressure of 15 PSI.

FIG. 4 is a side view schematic of a laminated anode having protective coatings as disclosed herein.

FIG. 5 is a flow diagram of a method of making the laminated anode having protective coatings as disclosed herein.

FIGS. 6A and 6B are SEM cross-sectional images of a laminated anode having protective coatings as disclosed herein, the images taken from the center of the anode and an edge of the anode, respectively, after a single charge cycle. The cell included a copper foil anode current collector, a polyethylene separator, a cathode material comprising lithium cobalt oxide and a liquid electrolyte comprising LiFSI, DME and PYR₁₃FSI.

FIG. 7 is an SEM cross-sectional image of a laminated anode having protective coatings as disclosed herein after a charge and discharge cycle. The cell included a copper foil anode current collector, a polyethylene separator, a cathode material comprising lithium cobalt oxide and a liquid electrolyte comprising LiFSI, DME and PYR₁₃FSI.

FIGS. 8A and 8B are enlarged portions of FIG. 7 illustrating stripping of virtually 100% of the lithium in some places with stripping exceeding 93% in all areas.

FIG. 9 is a cross-sectional schematic of a lithium metal battery cell.

### DETAILED DESCRIPTION

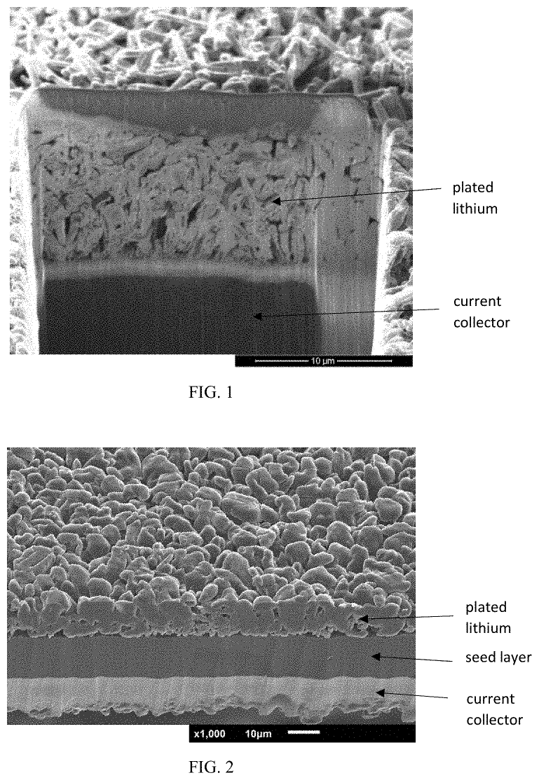

The dendritic plating caused by the corrosion of lithium metal, in some lithium anode materials, by liquid electrolytes can result in the anode swelling 300% or more in as few as tens of cycles. The dendritic plating has an inverse correlation to the cell pressure. At high cell pressure of 100 PSI or more, the dendritic plating can be at least partially mitigated. However, any gain in energy density by switching to a lithium metal anode over, for example, existing graphite anode technology, is lost due to the requirement of a mechanical restraint system required to apply the high cell pressure. FIG. 1 shows the dendritic plating that occurs in a cell under low pressure (15 PSI). The porous lithium growth seen in the SEM image of FIG. 1 was formed after only 0.3 hours of plating. The porous lithium layer is 13 μm thick, while the theoretical thickness was expected to be 1.6 μm. The SEM image clearly exhibits the swell that occurs due to the reactivity of the lithium metal with the liquid electrolyte.

Adding a seed layer of lithium to the anode current collector has been used to try to promote denser plating of the lithium metal during cycling. However, the plated lithium metal continues to be porous and dendritic, having a rough surface morphology. FIG. 2 is an SEM image of an anode current collector with a 20 μm seed layer of lithium metal after plating. The interface between the seed lithium and the plated lithium is clearly visible. The seed layer of lithium metal does not promote dense plating of lithium metal during battery cycling.

The addition of a LiPON layer to the anode has been evaluated in promoting dense lithium plating. LiPON is typically used in all solid-state constructions as the solid electrolyte due to its excellent stability with lithium metal. Because of this excellent stability, LiPON was explored as a potential layer in a liquid-based cell architecture. A LiPON layer was used as a layer to separate the lithium metal from the corrosive liquid electrolyte. The LiPON layer can either be deposited directly on the anode current collector or coated on top of lithium on the anode current collector.

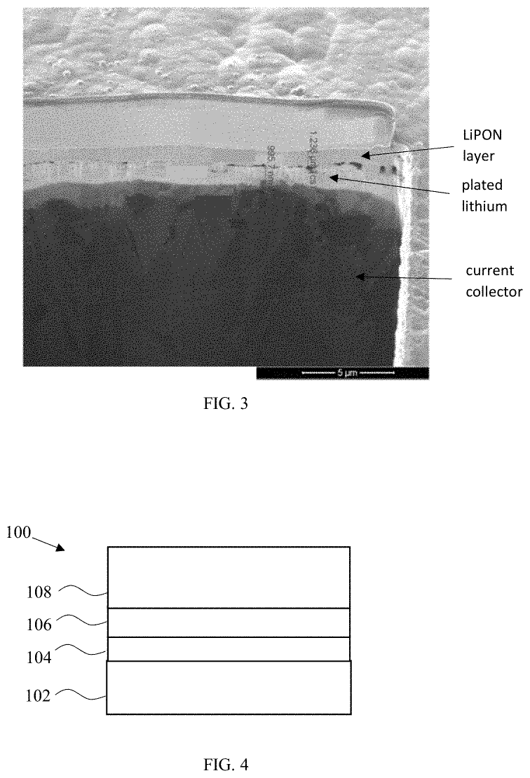

During initial cycling, the LiPON layer promoted dense plating in the liquid-based system. The LiPON layer promoted an essentially defect-free lithium plating, i.e., void of any morphology or grain boundaries. This is illustrated in the SEM image of FIG. 3, in which a LiPON layer is incorporated. Compare FIG. 3 to FIG. 1. The lithium layer is dense rather than porous and is only 1.0 μm in thickness after 0.3 hours of plating. The LiPON layer is between 1.0 μm and 2.0 μm in thickness.

This dense lithium layer seen in FIG. 3 differs from deposited seed layer of lithium metal in FIG. 2 formed by evaporation, which results in a large grain morphology with grain grooves at the intersection of grains. These grain boundaries are undesirable as they are preferentially stripped on discharge, leaving deep grooves and valleys. Liquid electrolyte pools in these areas and essentially provides a zero-pressure zone. On the subsequent plating cycle porous plating occurs in this region which leads to cell swell. This then repeats over subsequent cycles and the lithium seed is eroded vertically and laterally while porous lithium and reacted deposits rapidly grow vertically, leading to more extreme cell swell.

Although the LiPON layer was found to remain intact after some weeks of immersion in a liquid electrolyte, it was found that after a period of time, defects in the LiPON layer do occur. These defects present low resistance pathways for plated lithium metal to poke through the layer, eventually breaking out and over-plating the LiPON layer. Once an electronically conductive path exists on top of the electronically isolating LiPON layer, subsequent plating moves laterally along the surface of the LiPON layer and will eventually blanket the surface area. Accordingly, lithium metal cells using a LiPON layer alone did not result in a commercially viable battery cell.

Disclosed herein is an anode architecture that will permit dense plating of lithium in a typical low-pressure environment in a cell using liquid electrolyte. A low-pressure environment is, for example, under 20 PSI. The anode architecture disclosed herein has been operated successfully as low as 5 PSI. The anode architecture consists of coatings applied to a lithium metal battery anode to, first, separate the lithium metal from the corrosive liquid electrolyte and, second, laminate the anode to a conventional porous separator membrane. A multi-layer system is disclosed that includes a LiPON layer with an ionic conducting polymer layer cast on top of the LiPON layer. This polymer has four purposes—bridge any defects formed in the LiPON, act as a compliant layer to support the glass-like LiPON layer, apply internal pressure onto the lithium metal to further facilitate the dense plating promoted by the LiPON, and laminate the porous separator to the anode during casting.

The lamination of the separator to the polymer layer further eliminates the pooling of electrolyte on the anode structure. By laminating the separator to the anode with the polymer, any pockets of liquid electrolyte and free space for lithium metal to potentially plate between the polymer and the separator are eliminated. With this laminated structure, dense lithium plating void of any visible morphology roughness in a low-pressure environment is achieved.

FIG. 4 is a side view schematic of an anode as disclosed herein. The anode 100 includes a current collector 102 and a LiPON layer 104 on the current collector 102. The current collector 102 can be a copper foil, as a non-limiting example. The LiPON layer 104 is deposited on the current collector 102 using physical vapor deposition (PVD), as a non-limiting example. Alternatively, a seed layer of lithium metal can be deposited onto the current collector, and the LiPON layer can be deposited on top of the lithium metal seed layer. The LiPON layer can have a thickness of greater than or equal to 0.2 μm and less than or equal to 3.0 μm, and more particularly, a thickness of greater than or equal to 0.2 μm and less than or equal to 1.5 μm. The LiPON layer can be doped with one or more elements such as silicon and aluminum, as non-limiting examples.

A solid polymer layer 106 is coated on the LiPON layer 104, and a porous separator 108 is laminated to the solid polymer layer 106. The porous separator 108 can be, as non-limiting examples, a porous polyethylene membrane, a porous polyolefin membrane or a ceramic coated separator. The solid polymer layer 106 is one or more ion conducting linear polymers, such as polyDDA-X, wherein X is one or more of TFSI, FSI, PF₆, Cl, Br, and I, PVB, PVA, PVP, PUA and PVDF, as non-limiting examples. The solid polymer layer 106 also includes an ion conducting filler to provide ion conductivity to the layer.

The solid polymer layer 106 can have a thickness of greater than or equal to 1.0 μm and less than or equal to 5.0 μm, and more particularly, greater than or equal to 2.5 μm and less than or equal to 4 μm.

The solid polymer layer 106 can also be a solid polymer matrix formed of a solidified polymer network comprising a crosslinked polymer operated in an ion conducting filler. The solid polymer matrix used as the solid polymer layer 106 in the anodes disclosed herein is a novel solid polymer structure composed of a crosslinked polymer mixed with ion conducting filler, the mixture cured to crosslink and solidify the matrix. The solid polymer matrix is stable in the liquid electrolyte, non-reactive with lithium metal, laminates with the separator and is electrochemically stable within the operating voltage window. The solid polymer matrix operated in the ion conducting filler is formed from a crosslinked polymer such as crosslinked PEGDMA, crosslinked polyDDA-X, wherein X is one of TFSI, FSI, PF₆, Cl, Br, and I, crosslinked PVB, crosslinked PVA, crosslinked PVP, crosslinked PVDF, crosslinked PUA and others. The crosslinking polymers can be non-crosslinked, or linear, prior to curing, or can be pre-crosslinked, with additional crosslinking occurring when cured.

The ion conducting filler can comprise a polymer such as polyDDA-X, an ionic liquid and a lithium salt. The ion conducting filler can be an ionic liquid-containing electrolyte that is mixed with the linear or crosslinking polymers. The ionic liquid-containing electrolyte can be formed of an ionic liquid, a lithium salt and organic solvents. Non-limiting examples of ionic liquids include N-propyl-N-methylpyrrolidinium bis(fluorosulfonyl)imide (PYR₁₃FSI), N-butyl-N-methylpyrrolidinium bis(fluorosulfonyl)imide (PYR₁₄TFSI); N-propyl-N-methylpyrrolidinium bis(trifluoro-methanesulfonyl)imide (PYR₁₃TFSI); and N-butyl-N-methylpyrrolidinium bis(trifluoro-methanesulfonyl)imide (PYR₁₄TFSI). Non-limiting examples of organic solvents include 1,2-dimethoxyethane (DME), ethyl methyl carbonate (EMC), diethyl carbonate (DEC), and dimethyl carbonate (DMC). Non-limiting examples of the lithium salt is lithium bis(fluorosulfonyl)imide (LiFSI), lithium bis(trifluoromethanesulfonyl)imide (LiTFSI), and lithium bis(pentafluoroethanesulfonyl)imide (LiBETI). One or a combination of lithium salts can be used.

A solid polymer matrix as a solidified polymer network comprising a crosslinked PEGDMA matrix mixed with an ion conducting filler comprising a linearly chained polyDDA-Cl, PYR₁₃FSI and LiFSI was produced and tested in a liquid electrolyte. The solid polymer matrix remained intact for an extended period of time without gelling and dissolving into the liquid electrolyte. The solid polymer matrix laminated to a porous separator maintained the lamination strength after soaking in the liquid electrolyte for the same period of time.

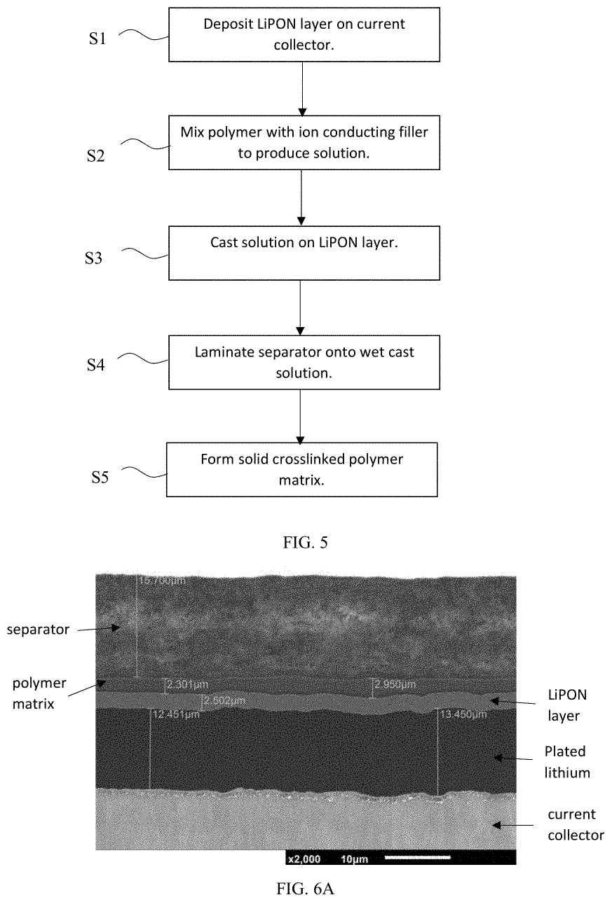

Methods of making the anode 100 for a lithium metal battery are also disclosed herein. One such method is diagrammed in FIG. 5. The LiPON layer 104 is deposited onto the current collector 102 in step S1. The LiPON layer 104 can be deposited using PVD, as a non-limiting example. Alternatively, a seed layer of lithium metal can be deposited onto the current collector using known evaporation techniques, and the LiPON layer 104 can be deposited onto the seed layer. In step S2, a polymer is mixed with an ion conducting filler to produce a solution. As noted, the polymer can be a linear polymer or can be pre-crosslinked. In step S3, the solution is cast on the LiPON layer 104 using known techniques. A porous separator 108 is laminated onto the solution while the solution is wet in step S4. After lamination, the polymer can be left to dry to produce the solid polymer layer 106 with no post-cross-linking. To fabricate the solid polymer matrix having the crosslinked polymer structure, the solution is cured using a photoinitiator and UV radiation or using thermal treatment, as non-limiting examples, in step S5.

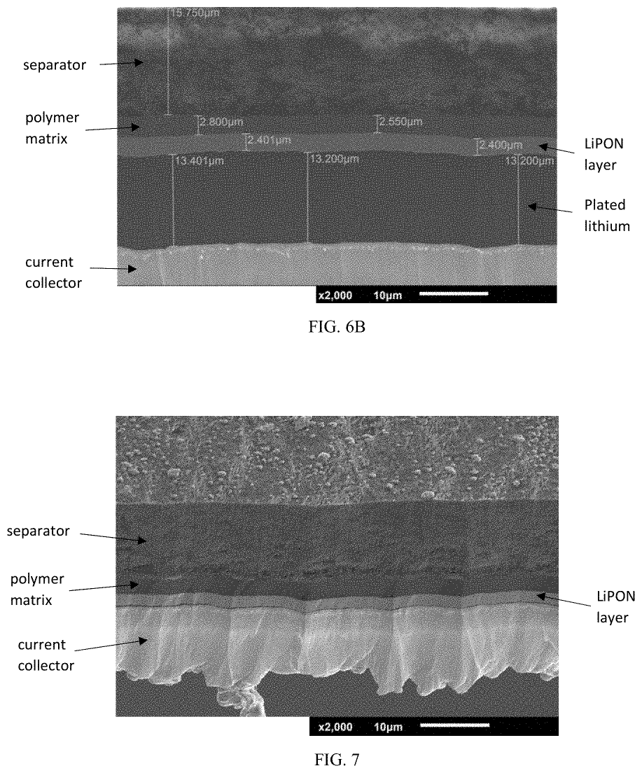

A cell was prepared by coating a 2.5 μm thick LiPON layer onto a copper foil current collector. A 3.0 μm thick polymer layer of a polyDDA-Cl and an ion conducting filler was cast onto the LiPON layer, and a porous polyethylene separator was laminated to the polymer layer. A cathode material comprising lithium cobalt oxide was used with a liquid electrolyte comprising LiFSI, DME and PYR₁₃FSI. FIG. 6A is an SEM cross-sectional image of an anode disclosed herein taken from the center of the cell after a single C/10 charge, and FIG. 6B is an SEM cross-sectional image of the anode taken from the edge of the cell after the single C/10 charge. After the single charge, both the LiPON layer and the polymer layer remain intact, having a continuous and uniform thickness. The lithium plated onto the copper free of defects and voids and at nearly 100% density. This is based on a theoretical value of 13 μm compared to the actual 13.2-13.4 μm actual measured thickness of the plated lithium. The consistency of the thicknesses of the layers in FIGS. 6A and 6B illustrates the uniformity of the layers across the anode. SEM EDS analysis indicates that the plated lithium layer shows only a small oxygen peak, the LiPON consisted of the expected peaks at P, O and N with no other elements indicated, and the polymer matrix consisted of peaks at F, S, N, O and C. The separator showed only a strong carbon peak with no sulfur, rinsing out well with no remaining electrolyte or byproducts.

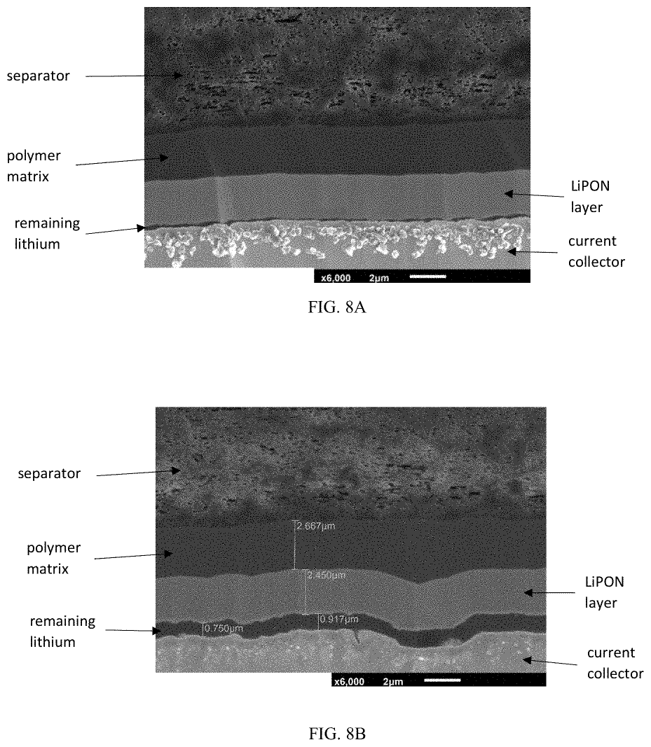

FIG. 7 is an SEM cross-sectional view of the anode in FIGS. 6A and 6B after a single C5 discharge. FIGS. 8A and 8B are enlarged views of portions of FIG. 7. Over 93% of the lithium was stripped, with virtually 100% of the lithium being stripped in some places. FIG. 8A shows virtually 100% of the lithium stripped from the anode, while FIG. 8B shows that the thickest remaining region of lithium still showed stripping of over 93% of the lithium.

The laminated anodes with protective coatings disclosed herein are chemically robust against and remain electrochemically active against liquid electrolytes used in lithium metal batteries. The laminated anodes with protective coatings enable dense lithium plating having no grain boundaries and achieve virtually 100% lithium plating density based on theoretical plating thickness. The solid polymer matrix bridges any defects that appear in the LiPON layer during cycling and provides a compliant support layer for the glass-like LiPON layer. The polymer matrix also provides a means to laminate the anode structure to the separator. This lamination removes the potential of lithium plating out between the separator and polymer.

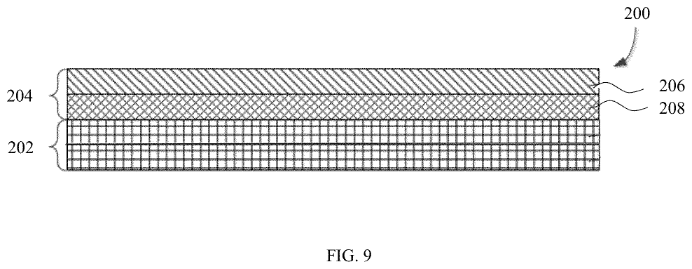

Also disclosed herein is a lithium metal battery cell 200 comprising the laminated anodes with protective coatings described above, and lithium metal batteries comprising a plurality of the cells 200. The layers of a cell are illustrated in cross-section in FIG. 9. The lithium metal battery 200 has an anode structure 202 as described with respect to the anode 100 of FIG. 4, which includes the laminated separator. The lithium metal battery 200 also has a cathode 204 with a cathode current collector 206 and a cathode active material 208 disposed over the cathode current collector 206. The cathode 204 and the anode 202 are separated by the separator that is laminated to the anode structure 202 and a liquid electrolyte.

The cathode current collector 206 can be, for example, an aluminum sheet or foil. Cathode active materials 208 can include one or more lithium transition metal oxides which can be bonded together using binders and optionally conductive fillers such as carbon black. Lithium transition metal oxides can include, but are not limited to, LiCoO₂, LiNiO₂, LiNi_{0.8}Co_{0.15}Al_{0.05}O₂, LiMnO₂, Li(Ni_{0.5}Mn_{0.5})O₂, spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. As needed, the cathode active material 208 can contain an electroconductive material, a binder, etc.

The liquid electrolyte is one known to those skilled in the art for use in a lithium-based battery. Non-limiting examples include a non-aqueous solution of a lithium salt dissolved in an organic solvent and/or an ionic liquid. The organic solvent is not particularly limited as long as it can dissolve an electrolyte salt being used, and one or more can be used. Examples of the organic solvent include propylene carbonate, ethylene carbonate, vinylene carbonate, dimethyl carbonate, ethyl methyl carbonate, diethyl carbonate, methyl propyl carbonate, isopropyl methyl carbonate, ethyl propionate, methyl propionate, γ-butyrolactone, ethyl acetate, methyl acetate, tetrahydrofuran, 2-methyltetrahydrofuran, ethyleneglycol dimethylether, ethyleneglycol diethylether, acetonitrile, dimethylsulfoxide, diethoxyethane and dimethoxyethane. The ionic liquid is also not particularly limited. Examples of the ionic liquid include aliphatic quaternary ammonium salts such as PYR₁₃FSI, PYR₁₄FSI, PYR₁₃TFSI and PYR₁₄TFSI, as well as alkyl imidazolium quanternary salts.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An anode for a lithium metal battery, comprising:
a current collector;
a LiPON layer on the current collector;
a solid polymer layer on the LiPON layer; and
a porous separator laminated to the solid polymer layer.

2. The anode of claim 1, wherein the solid polymer layer is one or more linear polymers selected from polyDDA-X, wherein X is one or more of TFSI, FSI, PF₆, Cl, Br, and I, PVB, PVA, PVP, PUA and PVDF, the one or more linear polymers mixed with an ion conducting filler.

3. The anode of claim 2, wherein the ion conducting filler comprises one or more of an ionic liquid polymer, an ionic liquid, a lithium salt and a solvent.

4. The anode of claim 1, wherein the solid polymer layer comprises:
a solid polymer matrix formed of a crosslinked polymer mixed with an ion conducting filler.

5. The anode of claim 4, wherein the crosslinked polymer is crosslinked PEGDMA, crosslinked polyDDA-X, crosslinked PVB, crosslinked PVA, crosslinked PVP, crosslinked PUA or crosslinked PVDF.

6. The anode of claim 4, wherein the ion conducting filler is linearly chained polyDDA-X, ionic liquid and a lithium salt.

7. The anode of claim 4, wherein the ion conducting filler is an ionic liquid-containing electrolyte including an ionic liquid, a lithium salt and a solvent.

8. The anode of claim 4, wherein the solid polymer matrix is a solidified polymer network comprising a crosslinked PEGMA matrix mixed with a linearly chained polyDDA-X, an ionic liquid and a lithium salt as the ion conducting filler.

9. The anode of claim 1, wherein the LiPON layer has a thickness of greater than or equal to 0.2 μm and less than or equal to 3 μm.

10. The anode of claim 1, wherein the solid polymer layer has a thickness of greater than or equal to 1 μm and less than or equal to 5 μm.

11. The anode of claim 1, further comprising:
a seed layer of lithium metal between the current collector and the LiPON layer.

12. A lithium metal battery, comprising:
the anode of claim 1, a cathode, and a liquid electrolyte, the lithium metal battery configured to operate at a pressure of 20 PSI or less.

13. An anode for a lithium metal battery comprising:
a current collector;
a LiPON layer on the current collector;
a solid polymer matrix on the LiPON layer, wherein the solid polymer matrix is a solidified polymer network comprising a crosslinked polymer operated in an ion conducting filler; and
a porous separator laminated to the solid polymer matrix.

14. The anode of claim 13, wherein the crosslinked polymer is one or more of crosslinked PEGDMA, crosslinked polyDDA-X, crosslinked PVB, crosslinked PVA, crosslinked PVP, crosslinked PUA or crosslinked PVDF and the ion conducting filler is an ionic liquid-containing electrolyte.

15. The anode of claim 13, wherein the crosslinked polymer is a crosslinked PEGDMA the ion conducting filler is a linearly chained polyDDA-X, an ionic liquid and a lithium salt.

16. The anode of claim 13, wherein the LiPON layer has a thickness of greater than or equal to 0.2 μm and less than or equal to 3 μm.

17. The anode of claim 13, wherein the solid polymer matrix has a thickness of greater than or equal to 1 μm and less than or equal to 5 μm.

18. The anode of claim 13, further comprising:
a seed layer of lithium metal between the current collector and the LiPON layer.

19. A method of making an anode for a lithium metal battery, the method comprising:
depositing a LiPON layer onto a current collector;
mixing a polymer with an ion conducting filler to produce a solution;
casting the solution on the LiPON layer;
laminating a porous separator onto the solution while the solution is wet; and
curing the solution to crosslink the polymer and form a solid polymer matrix.

20. The method of claim 19, wherein the polymer a linear and is one of PEGDMA, polyDDA-X, PVB, PVA, PVP, PUA or PVDF.

21. The method of claim 19, wherein the polymer is pre-crosslinked, with the curing further crosslinking the solution.

22. The method of claim 19, wherein the ion conducting filler is linearly chained polyDDA-X, ionic liquid and a lithium salt.

23. The method of claim 19, wherein the ion conducting filler is an ionic liquid-containing electrolyte including an ionic liquid, a lithium salt and a solvent.

24. The method of claim 19, wherein the LiPON layer is deposited using vapor deposition.
